(19) United States
(12) Patent Application Publication
(10) Pub. No.: US 2013/0002207 A1
(43) Pub. Date: Jan. 3, 2013

(54) Method for Calculating an Electric Current Provided by a Rechargeable Energy Storage System and Related Methods, Apparatuses, and Systems

(75) Inventor: Craig K. Wenger, Chandler, AZ (US)

(73) Assignee: Electric Transportation Engineering Corp. dba ECOtality North America, Phoenix, AZ (US)

(21) Appl. No.: 13/174,470

(22) Filed: Jun. 30, 2011

(51) Int. Cl. H02J 7/04

(52) U.S. Cl. 320/152

(57) ABSTRACT

Some embodiments include a method for calculating an electric current provided by a rechargeable energy storage system. Other embodiments of related methods, apparatuses, and systems are disclosed.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to methods for calculating an electric current, and relates more particularly to such methods for calculating an electric current provided by a rechargeable energy storage system and related methods, apparatus, and systems.

### DESCRIPTION OF THE BACKGROUND

Methods and systems for determining the state of charge of rechargeable energy storage systems for electric vehicles can be helpful both to operators of electric vehicles and operators of electric vehicle charging stations. Electric vehicle operators want to be able to confidently drive to their desired destinations without running out of electricity on the way. Being able to accurately review the state of charge of the rechargeable energy storage systems of the electric vehicles can provide the electric vehicle operators with this confidence. At the same time, being able to review and record the state of charge of the rechargeable energy storage systems can also provide electric vehicle operators with the ability to track and manage usage profiles of the rechargeable energy storage systems, which may be particularly beneficial for electric vehicle fleet operations. Meanwhile, electric vehicle charging station operators can also benefit from being able to determine the state of charge of rechargeable energy storage systems by knowing how much electricity to provide to rechargeable energy storage systems and/or how much electricity is available in rechargeable energy storage systems.

The state of charge of a rechargeable energy storage system can be determined either by electric voltage monitoring techniques or electric current monitoring techniques. In many cases, electric current monitoring techniques can provide a more accurate measurement of the state of charge because the electric voltage of electricity output by a rechargeable energy storage system may be affected by the temperature and/or the age of the rechargeable energy storage system. Electric shunts can be employed in rechargeable energy storage systems to measure electric current in the rechargeable energy storage systems; however, installing and/or calibrating these electric shunts can be complicated and expensive as a result of the lack of standardization between electric shunts and the cost of manufacturing these electric shunts from materials having known electrical properties (e.g., electric resistances).

Accordingly, a need or potential for benefit exists for methods and systems that allow for standardized, inexpensive, and/or accurate measurements of electric current of electricity being output by rechargeable energy storage systems.

### BRIEF DESCRIPTION OF THE DRAWINGS

To facilitate further description of the embodiments, the following drawings are provided in which:

FIG. 1 illustrates a block diagram of an apparatus, according to an embodiment;

FIG. 2 illustrates a management system for a rechargeable energy storage system, according to an embodiment;

FIG. 3 illustrates a computer system that is suitable for implementing an embodiment of a computer system of FIG. 1 and/or FIG. 2;

FIG. 4 illustrates a representative block diagram of an example of the elements included in the circuit boards inside a chassis of the computer system of FIG. 3.

FIG. 5 illustrates a flow chart for an embodiment of a method;

FIG. 6 illustrates a flow chart for an embodiment of another method;

FIG. 7 illustrates a flow chart for an embodiment of a method of providing an apparatus;

FIG. 8 illustrates a flow chart for an embodiment of a method of providing a management system for a rechargeable energy storage system; and

FIG. 9 illustrates an exemplary embodiment of the apparatus of FIG. 1.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “mobile electronic device” as used herein refers to at least one of a digital music player, a digital video player, a digital music and video player, a cellular phone (e.g., smartphone), a personal digital assistant, a handheld digital computer, or another device with the capability to display images and/or videos. For example, a mobile electrical device can comprise the iPod® or iPhone® or iTouch® or iPad® product by Apple Inc. of Cupertino, Calif. Likewise, a mobile electrical device can comprise a Blackberry® product by Research in Motion (RIM) of Waterloo, Ontario, Canada, or a different product by a different manufacturer.

The term “computer network” is defined as a collection of computers and devices interconnected by communications channels that facilitate communications among users and allows users to share resources (e.g., an internet connection, an Ethernet connection, etc.). The computers and devices can be interconnected according to any conventional network topology (e.g., bus, star, tree, linear, ring, mesh, etc.).

### DETAILED DESCRIPTION OF EXAMPLES OF EMBODIMENTS

Some embodiments include a method. The method can comprise: providing charging electricity to a rechargeable energy storage system; measuring a charging electric current of the charging electricity while the charging electricity is being provided to the rechargeable energy storage system; receiving a charging electric voltage difference measured at the rechargeable energy storage system while the charging electricity is being provided to the rechargeable energy storage system; receiving a charging temperature measured at the rechargeable energy storage system while the charging electricity is being provided to the rechargeable energy storage system; calculating a charging electrical resistance based upon the charging electric current and the charging electric voltage difference; and populating at least a first portion of a reference system configured to associate the charging electric resistance with the charging temperature, wherein the reference system is configured to be referenced to provide an operational electric resistance based upon an operational temperature measured at the rechargeable energy storage system in order to calculate an operational electric current provided by the rechargeable energy storage system to an electronic device.

Various embodiments include a method. The method comprises: providing operational electricity from a rechargeable energy storage system to an electronic device; measuring an operational electric voltage difference at the rechargeable energy storage system while the operational electricity is being provided to the electronic device; measuring an operational temperature at the rechargeable energy storage system while the operational electricity is being provided to the electronic device; referencing a reference system that is configured to associate an operational electric resistance with the operational temperature to determine the operational electric resistance that is present at the rechargeable energy storage system based on the operational temperature measured at the rechargeable energy storage system; and calculating an operational electric current of the operational electricity using the operational electric voltage difference and the operational electric resistance.

In some examples of the embodiments of the immediately previous paragraph, providing the operational electricity from the rechargeable energy storage system can comprise providing the operational electricity from the rechargeable energy storage system to an electric vehicle, the electronic device can comprise the electric vehicle, and the electric vehicle can comprise the rechargeable energy storage system. In some other examples of the embodiments of the immediately previous paragraph, measuring the operational electric voltage difference at the rechargeable energy storage system can comprise measuring the operational electric voltage difference across a conductive element of the rechargeable energy storage system while at least a portion of the operational electricity being provided to the electronic device is passing through the conductive element, and the conductive element can comprise an intercell connector. In further examples of the embodiments of the immediately previous paragraph, measuring the operational temperature at the rechargeable energy storage system can comprise measuring the operational temperature of a conductive element of the rechargeable energy storage system while at least a portion of the operational electricity being provided to the electronic device is passing through the conductive element, and the conductive element can comprise an intercell connector. Additionally, in some examples of the embodiments of the immediately previous paragraph, referencing the reference system that is configured to associate the operational electric resistance with the operational temperature can comprise communicating with a computer system comprising a table storing the operational electric resistance such that the operational electric resistance is associated with the operational temperature measured at the rechargeable energy storage system, and the reference system can comprise the table. Furthermore, in some examples of the embodiments of the immediately previous paragraph, calculating the operational electric current of the operational electricity can comprise communicating with a computer system configured to store the operational electric current to provide the operational electric current to the computer system. In other examples of the embodiments of the immediately previous paragraph, the method can further comprise: after measuring the operational electric voltage difference at the rechargeable energy storage system, measuring a second operational electric voltage difference at the rechargeable energy storage system while the operational electricity is being provided to the electronic device; after measuring the operational temperature at the rechargeable energy storage system, measuring a second operational temperature at the rechargeable energy storage system while the operational electricity is being provided to the electronic device; referencing the reference system to determine a second operational electric resistance that is present at the rechargeable energy storage system based on the second operational temperature measured at the rechargeable energy storage system; and calculating a second operational electric current of the operational electricity using the second operational electric voltage difference and the second operational electric resistance.

Further embodiments include an apparatus for providing charging electricity to a rechargeable energy storage system. The apparatus comprises conductive lines configured to be coupled to the rechargeable energy storage system. The apparatus also comprises a control module configured to be coupled with the conductive lines and to measure between the conductive lines a charging electric voltage difference at the rechargeable energy storage system. The apparatus comprises a measurement module configured to measure a charging electric current of the charging electricity while the charging station provides the charging electricity to the rechargeable energy storage system. The control module can be configured to receive from the measurement module a measurement of the charging electric current of the charging electricity and to receive a second measurement of a charging temperature at the rechargeable energy storage system. The control module can be configured to calculate a charging electric resistance based upon the charging electric current and the charging electric voltage difference. The control module can be configured to populate at least part of a reference system with the charging electric resistance such that the charging electric resistance is associated with the charging temperature. The reference system can be configured to be referenced to provide an operational electric resistance based upon an operational temperature measured at the rechargeable energy storage system in order to calculate an operational electric current provided by the rechargeable energy storage system to an electronic device.

Still further embodiments include a management system for a rechargeable energy storage system. The management system comprises a measurement module comprising conductive lines configured to be coupled to the rechargeable energy storage system. The management system comprises a reference module configured to reference a reference system that associates an operational electric resistance with an operational temperature to determine the operational electric resistance of the rechargeable energy storage system. The management system comprises a calculation module configured to communicate with the measurement module and the reference module. The measurement module can be configured to measure between the conductive lines an operational electric voltage difference at the rechargeable energy storage system while the rechargeable energy storage system is providing operational electricity to an electronic device. The measurement module can be configured to measure the operational temperature at the rechargeable energy storage system while the rechargeable energy storage system is providing operational electricity to the electronic device. The calculation module can be configured to calculate an operational electric current of the operational electricity by using the operational electric resistance and the operational electric voltage difference.

In some examples of the embodiments of the immediately previous paragraph, the electronic device can comprise an electric vehicle, and the electric vehicle can comprise the rechargeable energy storage system. In other examples of the embodiments of the immediately previous paragraph, the rechargeable energy storage system can comprise a conductive element, the conductive lines of the measurement module can be configured to be coupled to opposing ends of the conductive element, the conductive element can be configured such that at least a portion of the operational electricity passes through the conductive element when the rechargeable energy storage system is providing the operational electricity to the electronic device, and the measurement module can be configured to measure between the conductive lines the operational electric voltage difference across the conductive element while at least the portion of the operational electricity passes through the conductive element. In these or other examples, the conductive element can comprise an intercell connector. In these or other examples, the measurement module can be configured to measure the operational temperature at the rechargeable energy storage system by measuring the operational temperature of the conductive element. In further examples of the embodiments of the immediately previous paragraph, the management system can comprise a computer system, the reference system can comprise a table configured to associate the operational electric resistance with the operational temperature, the computer system can be configured to store the table, and the reference module can be configured to communicate with the computer system to reference the table in order to determine the operational electric resistance associated with the operational temperature measured at the rechargeable energy storage system. In additional examples of the embodiments of the immediately previous paragraph, the reference system can comprise a table configured to associate the operational electric resistance with the operational temperature, the reference module can be configured to communicate with a computer system to determine the operational electric resistance associated with the operational temperature measured at the rechargeable energy storage system, and the computer system can be located apart from the reference module.

Other embodiments include a method of providing an apparatus for providing charging electricity to a rechargeable energy storage system. The method can comprise: providing conductive lines configured to be coupled to the rechargeable energy storage system; providing a control module configured to be coupled with the conductive lines and to measure between the conductive lines a charging electric voltage difference at the rechargeable energy storage system; providing a measurement module configured to measure a charging electric current of the charging electricity while the charging station provides the charging electricity to the rechargeable energy storage system; and coupling each of the conductive lines to the control module. The control module can be configured to receive from the measurement module a measurement of the charging electric current of the charging electricity and to receive a second measurement of a charging temperature at the rechargeable energy storage system. The control module can be configured to calculate a charging electric resistance based upon the charging electric current and the charging electric voltage difference. The control module can be configured to populate at least part of the reference system with the charging electric resistance such that the charging electric resistance is associated with the charging temperature. The reference system can be configured to be referenced to provide an operational electric resistance based upon an operational temperature measured at the rechargeable energy storage system in order to calculate an operational electric current provided by the rechargeable energy storage system to an electronic device.

Still other embodiments include a method of providing a management system for a rechargeable energy storage system. The method can comprise: providing a measurement module comprising conductive lines configured to be coupled to the rechargeable energy storage system; providing a reference module configured to reference a reference system that associates an operational electric resistance with an operational temperature to determine the operational electric resistance of the rechargeable energy storage system; and providing a calculation module configured to communicate with the measurement module and the reference module. The measurement module can be configured to measure between the conductive lines an operational electric voltage difference at the rechargeable energy storage system while the rechargeable energy storage system is providing operational electricity to an electronic device. The measurement module can be configured to measure the operational temperature at the rechargeable energy storage system while the rechargeable energy storage system is providing operational electricity to the electronic device. The calculation module can be configured to calculate an operational electric current of the operational electricity by using the operational electric resistance and the operational electric voltage difference.

In some examples of the embodiments of the immediately previous paragraph, the electronic device can comprise an electric vehicle, and the electric vehicle can comprise the rechargeable energy storage system. In other examples of the embodiments of the immediately previous paragraph, the rechargeable energy storage system can comprise a conductive element, the conductive lines of the measurement module can be configured to be coupled to opposing ends of the conductive element, the conductive element can be configured such that at least a portion of the operational electricity passes through the conductive element when the rechargeable energy storage system is providing the operational electricity to the electronic device, and the measurement module can be configured to measure between the conductive lines the operational electric voltage difference across the conductive element while at least the portion of the operational electricity passes through the conductive element. In these or other examples, the conductive element can comprise an intercell connector. In these or other examples, the measurement module can be configured to measure the operational temperature at the rechargeable energy storage system by measuring the operational temperature of the conductive element. In further examples of the embodiments of the immediately previous paragraph, the management system can comprise a computer system, the reference system can comprise a table configured to associate the operational electric resistance with the operational temperature, the computer system can be configured to store the table, and the reference module can be configured to communicate with the computer system to reference the table in order to determine the operational electric resistance associated with the operational temperature measured at the rechargeable energy storage system. In additional examples of the embodiments of the immediately previous paragraph, the reference system can comprise a table configured to associate the operational electric resistance with the operational temperature, the reference module can be configured to communicate with a computer system to determine the operational electric resistance associated with the operational temperature measured at the rechargeable energy storage system, and the computer system can be located apart from the reference module.

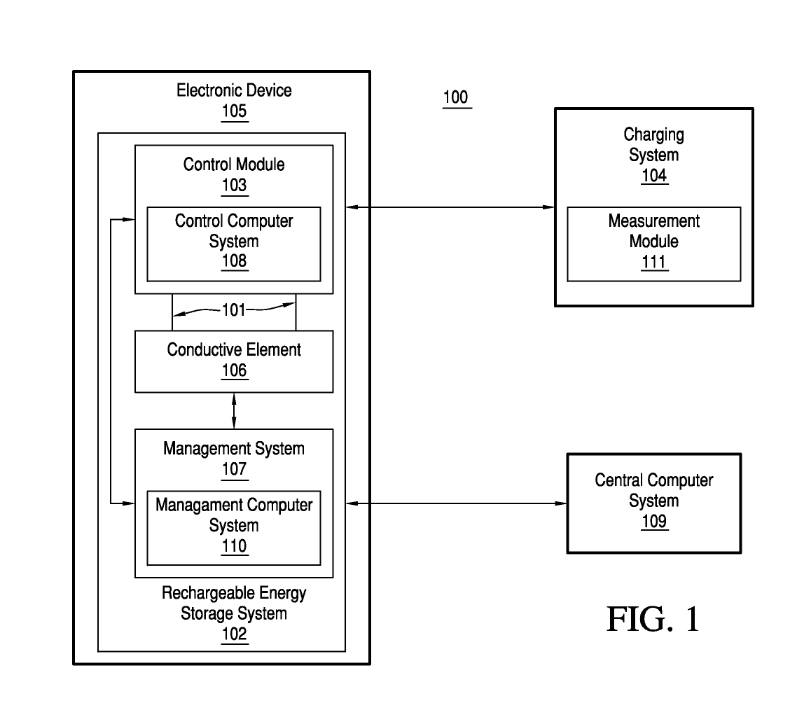

Turning to the drawings, FIG. 1 illustrates a block diagram of apparatus 100, according to an embodiment. Apparatus 100 is merely exemplary and is not limited to the embodiments presented herein. Apparatus 100 can be employed in many different embodiments or examples not specifically depicted or described herein.

Referring now to FIG. 1, apparatus 100 comprises conductive lines 101, control module 103, and measurement module 111. Apparatus 100 can comprise rechargeable energy storage system 102. Control module 103 can comprise control computer system 108. In some embodiments, apparatus 100 can comprise charging system 104, and charging system 104 can comprise control module 103 and/or measurement module 111. In other embodiments, rechargeable energy storage system 102 can comprise control module 103. Apparatus 100 can comprise electronic device 105, and electronic device 105 can comprise rechargeable energy storage system 102. Rechargeable energy storage system 102 can comprise conductive element 106 and/or management system 107. Management system 107 can comprise management computer system 110. Apparatus 100 can also comprise central computer system 109. In some embodiments, control computer system 108 can be management system 107 and/or management computer system 110, and vice versa. Each of conductive lines 101, control module 103, control computer system 108, charging system 104, electronic device 105, rechargeable energy storage system 102, conductive element 106, management system 107, measurement module 111, and management computer system 110 is described in further detail herein.

Each conductive line of conductive lines 101 is configured to be coupled to rechargeable energy storage system 102. Each conductive line of conductive lines 101 can be coupled to rechargeable energy storage system 102 directly (e.g., by soldering, by wrapping, etc.) or via a removable coupling mechanism (e.g., an alligator clip, or another suitable removable coupling mechanism).

Rechargeable energy storage system 102 can comprise (a) one or more batteries and/or one or more fuel cells, (b) one or more capacitive energy storage systems (e.g., super capacitors such as electric double-layer capacitors), and/or (c) one or more inertial (e.g., flywheel) energy storage systems. In many embodiments, the one or more batteries can comprise one or more rechargeable (e.g., traction) and/or non-rechargeable batteries. For example, the one or more batteries can comprise one or more of a lead-acid battery, a valve regulated lead acid (VRLA) battery such as a gel battery and/or an absorbed glass mat (AGM) battery, a nickel-cadmium (NiCd) battery, a nickel-zinc (NiZn) battery, a nickel metal hydride (NiMH) battery, a zebra (e.g., molten chloroaluminate (NaAlCl₄)) battery and/or a lithium (e.g., lithium-ion (Li-ion)) battery. In some embodiments, where the rechargeable energy storage system comprises more than one battery, the batteries can all comprise the same type and/or size of battery. In other embodiments, where the rechargeable energy storage system comprises more than one battery, the batteries can comprise at least two different types and/or sizes of batteries. In many embodiments, the at least one fuel cell can comprise at least one hydrogen fuel cell.

Rechargeable energy storage system 102 comprises conductive element 106. Conductive element 106 is configured such that at least a portion of the charging electricity passes through conductive element 106 when charging system 104 is providing the charging electricity to rechargeable energy storage system 102. Accordingly, each conductive line of conductive lines 101 can be configured to be coupled to opposing ends of conductive element 106. Where rechargeable energy storage system 102 comprises one or more batteries and/or one or more fuel cells, conductive element 106 can comprise an intercell connector. The intercell connector can be configured to electrically couple together cells of rechargeable energy storage system 102. In many embodiments, conductive element 106 is not a shunt.

Referring again to FIG. 1, apparatus 100 comprises control module 103. Control module 103 is configured to be coupled to conductive lines 101. Coupling conductive lines 101 to control module 103 can establish electrical communication (e.g., by forming an electric circuit) between conductive lines 101 and control module 103. Accordingly, control module 103 is configured to measure a charging electric voltage difference at rechargeable energy storage system 102. Specifically, control module 103 can be configured to measure the charging electric voltage difference between conductive lines 101 when conductive lines 101 are coupled to control module 103 and to rechargeable energy storage system 102 so as to establish electrical communication (e.g., to form the electrical circuit) between conductive lines 101 and control module 103.

Referring to FIG. 1, in many embodiments, control module 103 can be configured to communicate with charging system 104. Accordingly, in many embodiments, control module 103 can comprise a communication module configured to facilitate communication between control module 103 and charging system 104. Control module 103 and/or the communication module can be configured to communicate with charging system 104 via a wired connection (e.g., an electrical bus connection, an Ethernet connection, a Powerline connection, etc.) and/or a wireless connection (e.g., (1) any suitable wireless computer network connection, for example, an 802.11 wireless local area network (WLAN) connection, a Bluetooth connection, and the like, (2) any suitable cellular telephone network connection, for example, a code division multiple access (CDMA) (e.g., IS-95) network, a global system for mobile communications (GSM) network, a time division multiple access (TDMA) network, and/or an orthogonal frequency-division multiplexing (OFDM) network, and the like, and (3) any other suitable wireless connection medium).

Charging system 104 can be configured to provide charging electricity to rechargeable energy storage system 102. Likewise, rechargeable energy storage system 102 can be configured to provide operational electricity to electronic device 105. Although electronic device 105 can comprise any electronic device incorporating electrical components, in many embodiments, electronic device 105 comprises an electric vehicle. In these embodiments as well as in other embodiments where electronic device 105 does not comprise the electric vehicle, electronic device 105 (e.g., the electric vehicle) can comprise rechargeable energy storage system 102. Still, in many examples, rechargeable energy storage system 102 may still be removable from electronic device 105 for purposes of providing electricity to rechargeable energy storage system 102.

Accordingly, where electronic device 105 comprises the electric vehicle, charging system 104 can comprise an electric vehicle charging station. Nonetheless, where electronic device 105 does not comprise the electric vehicle, charging system 104 can also be any other device (e.g., a mobile electronic device charging system) configured to provide electricity to electronic device 105.

The electric vehicle can comprise a full electric vehicle and/or any other grid-connected vehicle. For example, the electric vehicle can comprise a car, a truck, motorcycle, a bicycle, a scooter, a boat, a train, an aircraft, an airport ground support equipment, and/or a material handling equipment (e.g., a fork-lift), etc.

Meanwhile, in some embodiments, the electric vehicle charging station can comprise personal and/or commercial electric vehicle supply equipment. In other embodiments, the electric vehicle charging station can comprise industrial electric vehicle supply equipment (e.g., an on-board alternating current (AC) electric charger, an off-board direct current (DC) electric charger). Whether being configured for personal, commercial, and/or industrial applications, the electric vehicle charging station can be configured to provide electricity to rechargeable energy storage system 102 by conductive electricity transfer. Likewise, in some embodiments, whether being configured for personal, commercial, and/or industrial applications, where the electric vehicle charging station is configured to operate with AC electricity, the electric vehicle charging station can convert the AC electricity to DC electricity (e.g., charging electricity) before providing the charging electricity to rechargeable energy storage system 102. Accordingly, in these embodiments, when charging system 104 and/or measurement module 111 measure the charging electric current of the charging electricity, as described below, charging system 104 and/or measurement module 111 can measure the charging electric current of the DC electricity rather than the AC electricity.

Personal and/or commercial electric vehicle supply equipment can comprise level 1 electric vehicle supply equipment, level 2 electric vehicle supply equipment, and/or level 3 electric vehicle supply equipment. Level 1 electric vehicle supply equipment can comprise either of level 1 alternating current (AC) electric vehicle supply equipment or level 1 direct current (DC) electric vehicle supply equipment. Meanwhile, level 2 electric vehicle supply equipment can comprise either of level 2 AC electric vehicle supply equipment or level 2 DC electric vehicle supply equipment. Furthermore, level 3 electric vehicle supply equipment can comprise either of level 3 AC electric vehicle supply equipment or level 3 DC electric vehicle supply equipment. In some embodiments, level 2 electric vehicle supply equipment and/or level 3 electric vehicle supply equipment can also be referred to as a fast charger. In many embodiments, personal and/or commercial electric vehicle supply equipment can be configured to provide electricity comprising a maximum electric current of 30 amperes (A) or 48 A. When the maximum electric current of the personal and/or commercial electric vehicle supply equipment comprises 30 A, the electric vehicle supply equipment can be configured to provide electricity comprising an electric current of one or more of 12 A, 16 A, or 24 A. When the maximum electric current of the personal and/or commercial electric vehicle supply equipment comprises 48 A, the electric vehicle supply equipment can be configured to provide electricity comprising an electric current of one or more of 12 A, 16 A, 24 A, or 30 A.

For example, level 1 AC electric vehicle supply equipment can be configured to provide electricity comprising an electric voltage of approximately 120 volts (V) and an electric current: (a) greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, level 1 electric vehicle supply equipment can comprise a standard grounded domestic electrical outlet. Meanwhile, level 2 AC electric vehicle supply equipment can be configured to provide electricity comprising an electric voltage greater than or equal to approximately 208 V and less than or equal to approximately 240 V, and an electric current greater than or equal to approximately 0 A and less than or equal to approximately 80 A AC. Furthermore, level 3 AC electric vehicle supply equipment can be configured to provide electricity comprising an electric voltage greater than or equal to approximately 208 V, and an electric current greater than or equal to approximately 80 A AC (e.g., 240 V AC (single phase), 208 V AC (triple phase), 480 V AC (triple phase). In some embodiments, the electric voltages for level 1 electric vehicle supply equipment, level 2 electric vehicle supply equipment, and/or level 3 electric vehicle supply equipment can be within plus or minus (±) ten percent (%) tolerances of the electric voltages provided above.

In other examples, level 1 DC electric vehicle supply equipment can be configured to provide electricity comprising electric power greater than or equal to approximately 0 kiloWatts (kW) and less than or equal to approximately 19 kW. Meanwhile, level 2 DC electric vehicle supply equipment can be configured to provide electricity comprising electric power greater than or equal to approximately 19 kW and less than or equal to approximately 90 kW. Furthermore, level 3 DC electric vehicle supply equipment can be configured to provide electricity comprising electric power greater than or equal to approximately 90 kW. In some embodiments, the term fast charger can refer to personal and/or commercial electric vehicle supply equipment configured to provide electricity comprising an electric voltage between approximately 300 V-500 V and an electric current between approximately 100 A-400 A DC.

Industrial electric vehicle supply equipment (e.g., the on-board AC electric charger, the off-board DC electric charger) can be configured to provide electricity comprising electric power greater than or equal to approximately 3 kW and less than or equal to approximately 33 kW. The off-board DC electric charger can be configured to provide electricity comprising an electric voltage greater than or equal to approximately 18 V DC and less than or equal to approximately 120 V DC.

In some embodiments, charging system 104 can comprise apparatus 100, or vice versa, and/or control module 103. In other embodiments, charging system 104 can be separate and/or remote from apparatus 100 and/or control module 103. For example, in some embodiments, apparatus 100 and/or control module 103 can be incorporated in charging system 104. Alternatively, in the other embodiments, apparatus 100 and/or control module 103 can be portable and/or configured to interface (e.g., by wire and/or wirelessly) with charging system 104, such as, while charging system 104 is providing charging electricity to rechargeable energy storage system 104. In still other embodiments, apparatus 100 and/or control module 103 can be part of and/or located at rechargeable energy storage system 102.

In some embodiments, apparatus 100 can comprise measurement module 111. Measurement module 111 can be configured to measure a charging electric current of the charging electricity while the charging station provides the charging electricity to the rechargeable energy storage system. In some embodiments, charging system 104 can comprise measurement module 111. Measurement module 111 can be configured to communicate with control module 103 in a similar or identical manner to how control module 103 communicates with charging system 104, as described above. In many embodiments, control system 103 can be part of and/or located at rechargeable energy storage system 102 and measurement module 111 can be part of and/or located at charging system 104.

In operation, apparatus 100 and/or control module 103 can be configured to receive from measurement module 111 and/or charging system 104 a measurement of a charging electric current of the charging electricity being provided (e.g., by charging system 104) to rechargeable energy storage system 102 and/or passing through conductive element 106. In various embodiments, measurement module 111 and/or charging system 104 can be configured to measure the measurement of the charging electric current of the charging electricity while providing the charging electricity to rechargeable energy storage system 102. Measurement module 111 and/or charging system 104 can be configured to measure the measurement of the charging electric current with a Hall effect sensor, a magnetic field based detector, or any other suitable device for measuring electric current. Accordingly, in many embodiments, measurement module 111 and/or charging system 104 can comprise a Hall effect sensor, a magnetic field based detector, or any other suitable device for measuring electric current. Control module 103 is configured to receive (e.g., from measurement module 111 and/or charging system 104 via the communication module) the measurement of the charging electric current of the charging electricity from charging system 104. In some embodiments, control module 103 can be configured to measure the measurement of the charging electric current of the charging electricity (as opposed to measurement module 111 and/or charging system 104 measuring the measurement) while charging system 104 provides the charging electricity to rechargeable energy storage system 102.

Apparatus 100 and/or control module 103 can be configured to receive a second measurement of a charging temperature at rechargeable energy storage system 102 and/or at conductive element 106. In some embodiments, control module 103 can be configured to receive the measurement of the charging temperature at rechargeable energy storage system 102 and/or at conductive element 106 by measuring the charging temperature of conductive element 106. In these embodiments, control module 103 can comprise a thermocouple or any other suitable device being configured to measure the charging temperature of conductive element 106. In the same or different embodiments, rechargeable energy storage system 102 can comprise management system 107 (e.g., a battery management system (BMS) where rechargeable energy storage system 102 comprises one or more batteries). Management system 107 can be configured to measure the charging temperature of conductive element 106. Thus, in other embodiments, control module 103 can be configured to receive the measurement of the charging temperature at rechargeable energy storage system 102 from management system 107.

Meanwhile, when each of conductive line of conductive lines 101 is coupled to rechargeable energy storage system 102 and/or conductive element 106 (e.g., to complete an electric circuit) and while charging system 104 is providing charging electricity to rechargeable energy storage system 102, control module 103 can be configured to measure the charging electric voltage difference across conductive element 106 and/or between conductive lines 101 while the charging electricity passes through conductive element 106.

Control module 103 can be configured to calculate a charging electric resistance based upon the charging electric current and the charging electric voltage difference. Specifically, after receiving and/or measuring the charging electric current and measuring the charging electric voltage difference, control module 103 can calculate the charging electric resistance according to Ohm's law stating that the electric current (e.g., the charging electric current) between two electrically coupled points of rechargeable energy storage system 102 and/or conductive element 106 is directly proportional to the electric voltage difference (e.g., the charging electric voltage difference) across the two electrically coupled points, and is inversely proportional to the electric resistance (e.g., the charging electric resistance) between the two electrically coupled points.

Control module 103 can be configured to populate at least part of a reference system (e.g., a table, a matrix, a spreadsheet, a list, etc.) with the charging electric resistance. The charging electric resistance can be populated at the reference system such that the charging electric resistance is associated with the charging temperature measured at rechargeable energy storage system 102 and/or conductive element 106 when the charging electric voltage and the charging electric current (used to calculate the charging electric resistance) were measured. Accordingly, the reference system can be configured to be referenced while and/or after rechargeable energy storage system 102 provides operational electricity to electronic device 105 to provide an operational electric resistance that is/was present at rechargeable energy storage system 102 and/or conductive element 106. The operational electric resistance can be determined based upon an operational temperature measured at rechargeable energy storage system 102. Specifically, by referencing the operational temperature against the charging temperature recorded at the reference system, the appropriate charging electric resistance associated with that charging temperature can then provide a corresponding operational electric resistance without measuring the operational electric resistance. That is to say, the charging electric resistance corresponding to the charging temperature can be the same as the operational electric resistance corresponding to the operational temperature. Upon determining the operational electric resistance, the operational electric resistance can be used, in reverse fashion, to calculate an operational electric current of the operational electricity provided by rechargeable energy storage system 102 to electronic device 105 after measuring the operational electric voltage difference across conductive element 106 and/or rechargeable energy storage system 102.

For purposes of clarity, when used herein, the modifiers of “charging” and “operational” as used with respect to the terms “electricity,” “electric current,” “electric voltage difference,” and/or “electric resistance” are intended to distinguish the state of operation of rechargeable energy storage system 102 and are not intended to imply quantitative differences between the modified terms. Specifically, the modifier “charging” is applied when rechargeable energy storage system 102 is receiving electricity while the modifier “operational” is applied when rechargeable energy storage system 102 is providing electricity to electronic device 105. For further exemplary purposes, it should thus be understood that “charging electric current” can be equal to or approximately equal to “operational electric current,” the distinction being only whether the electric current is being provided to or output from rechargeable energy storage supply 102.

As charging system 104 provides charging electricity to rechargeable energy storage system 102 and/or as rechargeable energy storage system 102 provides operational electricity to electronic device 105, rechargeable energy storage system 102 and/or conductive element 106 will naturally start to heat up over time as some of the charging electricity/operational electricity converts to heat. As the temperature of rechargeable energy storage system 102 and/or conductive element 106 changes, so too does the electric resistance of rechargeable energy storage system 102 and/or conductive element 106 change. Accordingly, accuracy in measuring the electric current passing to and/or from rechargeable energy storage system 102 can be increased by accounting for the changing electric resistance of rechargeable energy storage system 102 and/or conductive element 106 by using the aforementioned reference system.

Consequently, apparatus 100 and/or control module 103 can be configured to populate the reference system for multiple corresponding electric resistances and temperatures of rechargeable energy storage system 102 and/or conductive element 106 while charging system 104 is providing charging electricity to rechargeable energy storage system 102. In so doing, apparatus 100 and/or control module 103 can auto- or self-calibrate in real time the reference system according to rechargeable energy storage system 102 and/or conductive element 106. Indeed, each reference system can thus be uniquely calibrated to its respective rechargeable energy storage system. Accordingly, one advantage of apparatus 100 (FIG. 1) over alternative shunt-based calculation of electric current output from rechargeable energy storage system 102 is that the electric current can be uniquely calculated for rechargeable energy storage system 102 as a system as opposed to merely being calculated for conductive element 106. As a result, even where rechargeable energy storage system 102 is configured with additional conductive elements operating as intercell connectors (e.g., where rechargeable energy storage system 102 is configured for fast charging), the reference system will remain accurately calibrated to rechargeable energy storage system 102 as a system.

As described above, the temperature will increase naturally over time as a result of the receipt and/or output of electricity by rechargeable energy storage system 102. Accordingly, the electric resistances (e.g., charging electric resistances) can be calculated and recorded at any predetermined and/or standardized temperature (e.g., charging temperature) or time interval. In some embodiments, temperature intervals can be determined according to the season. For reference purposes, in some embodiments, where the measured operational temperature falls in between recorded charging temperatures and/or outside of the range of the recorded charging temperatures, numerical methods (e.g., interpolation, extrapolation, etc.) can be employed to determine the appropriate operational electric resistance for the operational temperature. In further embodiments, the reference system can be utilized to generate an equation to determine the operational electric resistance. For example, the reference system can be utilized to generate an equation modeling operational electric resistance as a function of operational temperature. In other embodiments, where the measured operational temperature falls in between recorded charging temperatures and/or outside of the range of the recorded temperatures, the operational temperature can be rounded to the nearest charging temperature, thereby providing the charging electric resistance (i.e., operating electric resistance) associated therewith. Accordingly, where numerical methods are unavailable such that a rounding methodology is implemented when referencing the reference system, desired accuracy may still be able to be achieved by increasing the number of electric resistance(s) and corresponding temperature(s) populating the reference system.

In many embodiments, apparatus 100 and/or control module 103 can be configured to dynamically populate the reference system (1) throughout each instance of charging system 104 providing charging electricity to rechargeable energy storage system 102, (2) periodically throughout each instance of charging system 104 providing charging electricity to rechargeable energy storage system 102, and/or (3) upon predetermined intervals (e.g., every other charge, every five charges, every ten charges, etc.) of charging system 104 providing charging electricity to rechargeable energy storage system 102. In this way, populating the reference system can refer to recording one or more electric resistances and one or more corresponding temperatures either for the first time or a subsequent time where the electric resistance(s) have subsequently changed from a previous calibration. Likewise, in some examples, when recalibrating and/or updating the reference system, each of the electric resistance(s) and/or corresponding temperatures may be repopulated; however, in other embodiments, only some of the electric resistance(s) and/or corresponding temperatures may be repopulated. For example, where a subsequent window of measured charging temperatures falls within a previous window of measured charging temperatures, the electric resistance(s) may be repopulated only with respect to those charging electric resistance(s) corresponding to the measured charging temperature(s). In various embodiments, the reference system may be initially populated empirically with default electric resistance(s) and corresponding temperature(s).

In some embodiments, the electric resistances (e.g., charging electric resistances) calculated to populate the reference system can be average electric resistances of multiple electric resistances calculated. In these embodiments, the electric resistances can be average electric resistances calculated during the same calibration (e.g., where electric resistances are calculated upon time intervals) and/or can be average electric resistances calculated during multiple calibrations (e.g., where the present electric resistance(s) calculated is averaged with one or more previous electric resistance(s) calculated during one or more prior instances of charging system 104 providing charging electricity to rechargeable energy storage system 102).

In a typical calibration of the reference system for rechargeable energy storage system 102, electric current measurements may vary by hundreds of Amperes, and electric voltage difference measurements may vary by thousandths of a Volt such that electric resistance calculations may vary by thousandths and/or millionths of an Ohm. Likewise, temperatures of rechargeable energy storage system 102 and/or conductive element 106 could be expected to vary by greater than or equal to approximately negative twenty (20) degrees Celsius and less than or equal to approximately positive forty-five degrees (45) degrees Celsius.

As mentioned briefly above, after the reference system has been calibrated, apparatus 100 permits calculation of the operational electric current of the operational electricity provided by rechargeable energy storage system 102 to electronic device 105 by referencing to the reference system. As a result, by summing the aggregate operational electric current output by rechargeable energy storage system 102 and by knowing the original state of charge of rechargeable energy storage system 102, it is possible to accurately determine a present state of charge of rechargeable energy storage system 102.

For example, the operational electric current output from rechargeable energy storage system 102 can be determined either (1) simultaneously with rechargeable energy storage system 102 providing the operational electricity to electronic device 105 by calculating the operational electric current using measurements of operational electric voltage differences and operational temperatures (e.g., to determine operational electric resistances by reference to the reference system) of rechargeable energy storage system 102 as the operational electricity is being provided to electronic device 105 or (2) subsequently by recording and/or storing (e.g., at one or more storage modules of control computer system 108, management computer system 110, and/or central computer system 109, respectively, as described below) the measurements of the operational electric voltage differences, operational temperatures, and/or operational electric resistances and calculating the operational electric currents at a later time. In any event, the operational electric current output that is calculated can be stored at control computer system 108, central computer system 109, and/or management computer system 110, as described below, in the form of charge data regarding the operational electric current output and/or state of charge of rechargeable energy storage system 102.

The charge data can be useful for providing electric vehicle operators with an accurate indication of the state of charge (e.g., by a gauge in the electric vehicle) of rechargeable energy storage system 102. The data also can be useful to operators of charging system 104 to indicate how much charging electricity is needed to charge rechargeable energy storage system 102. The data may further be useful to electric vehicle operators, particularly with respect to fleet electric vehicle operators, in determining usage profiles of their electric vehicle (electric vehicle fleet) and for performing equalization charges. In this way, for example, electric vehicle operators and/or fleet operators can monitor whether certain of their electric vehicles receive more use than others to track wear on rechargeable energy storage systems, tires, or any other components of their electric vehicle(s). Accordingly, the electric vehicle operators and/or fleet operators can compensate for these inequities by establishing different usage routines. Meanwhile, for industrial applications, such as where rechargeable energy storage system 102 is providing operational electricity to an industrial electric vehicle like a fork-lift, the charge data may also provide an early warning of the state of charge in advance of a lift interrupt condition.

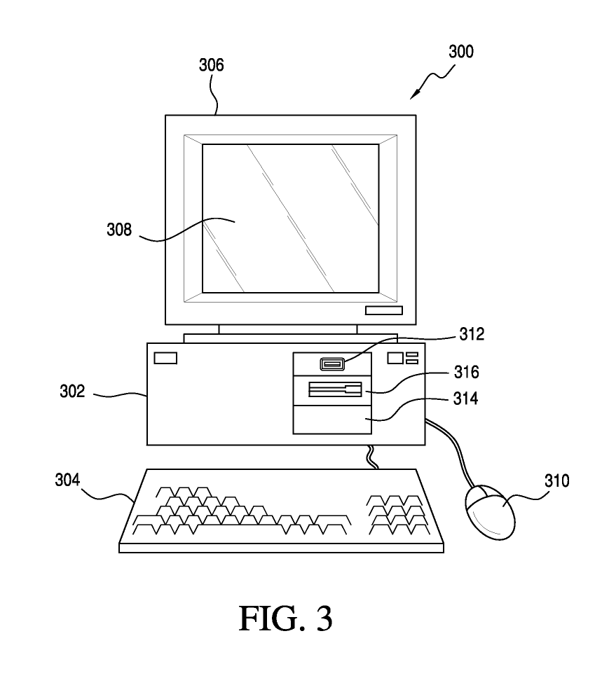

In some embodiments, apparatus 100 and/or control module 103 can be configured to communicate (e.g., through internal wiring and/or via the communication module, as applicable) with control computer system 108. In the same or different embodiments, apparatus 100 and/or control module 103 can be configured to communicate (e.g., via the communication module) with central computer system 109. In still others of the same or different embodiments, apparatus 100 and/or control module 103 can be configured to communicate (e.g., through internal wiring and/or via the communication module, as applicable) with management system 107 and/or management computer system 110. Each of control computer system 108, central computer system 109, and/or management computer system 110 can be similar or identical to computer system 300 (FIG. 3), as described below.

In some embodiments, apparatus 100, control module 103, rechargeable energy storage system 102 and/or charging system 104 can comprise control computer system 108 and/or central computer system 109. In many embodiments, central computer system 109 can be separate from and/or located remotely from apparatus 100, control module 103, charging system 104 and/or electronic device 105. In these embodiments, central computer system 109 can be operated by an administrator of an electric vehicle charging network, by an electric vehicle owner/operator, and/or an administrator of a fleet of electric vehicles. In various embodiments, rechargeable energy storage system 102 and/or management system 107 can comprise management computer system 110. Apparatus 100, rechargeable energy storage system 102, control module 103, charging system 104, management system 107, control computer system 108, central computer system 109 and/or management computer system 110 can be configured to communicate together and/or be synchronized, as applicable. In some embodiments, such as where rechargeable energy storage system 102 comprises control module 103, control computer system 108 can be management system 107 and/or management computer system 110, and vice versa, as mentioned above. In other embodiments, control computer system 108 can be different and/or separate from management computer system 110.

One or more of control computer system 108, central computer system 109, and/or management computer system 110 can be configured to store (e.g., via a storage module of the relevant computer system) the reference system and/or the charge data. The reference system and/or the charge data can be stored as part of a table or a computer database. For example, the computer database can be implemented as one or more of an XML (Extensible Markup Language) database, MySQL, or an Oracle® database. Accordingly, in many embodiments, the reference system and/or charge data can be stored locally at rechargeable energy storage system 102 and/or electronic device 105 and/or remotely at a location of central computer system 109.

Apparatus 100, control module 103, charging system 104, and/or control computer system 108 can be configured to communicate with central computer system 109, management system 107, and/or management computer system 110 to provide charging electric resistance(s) calculated and charging temperature(s) measured to central computer system 109, management system 107, and/or management computer system 110 in order to store (i.e., populate) the charging electric resistance(s) and charging temperature(s) as part of the calibrated reference system for reference purposes while and/or after rechargeable energy storage system 102 is providing operational electricity to electronic device 105. Accordingly, any of control computer system 108, central computer system 109, and/or management computer system 110 can be configured to communicate with each other to provide and retrieve the reference system and/or charge data, as applicable. In the same or different embodiments, control module 103 and/or control computer system 108 can be configured to store the reference system and/or charge data locally (e.g., at one or more storage modules of control computer system 108), such as, when rechargeable energy storage system 102 comprises control module 103. Control system 108, central computer system 109, and/or management computer system 110 can be configured to communicate with each other via a wired connection (e.g., an electrical bus connection, an Ethernet connection, a Powerline connection, etc.) and/or a wireless connection (e.g., (1) any suitable wireless computer network connection, for example, an 802.11 wireless local area network (WLAN) connection, a Bluetooth connection, and the like, (2) any suitable cellular telephone network connection, for example, a code division multiple access (CDMA) (e.g., IS-95) network, a global system for mobile communications (GSM) network, a time division multiple access (TDMA) network, and/or an orthogonal frequency-division multiplexing (OFDM) network, and the like, and (3) any other suitable wireless connection medium).

Likewise, any of control system 108, central computer system 109, and/or management computer system 110 can be configured to perform any of the calculations of control module 103 and/or management system 107, as applicable.

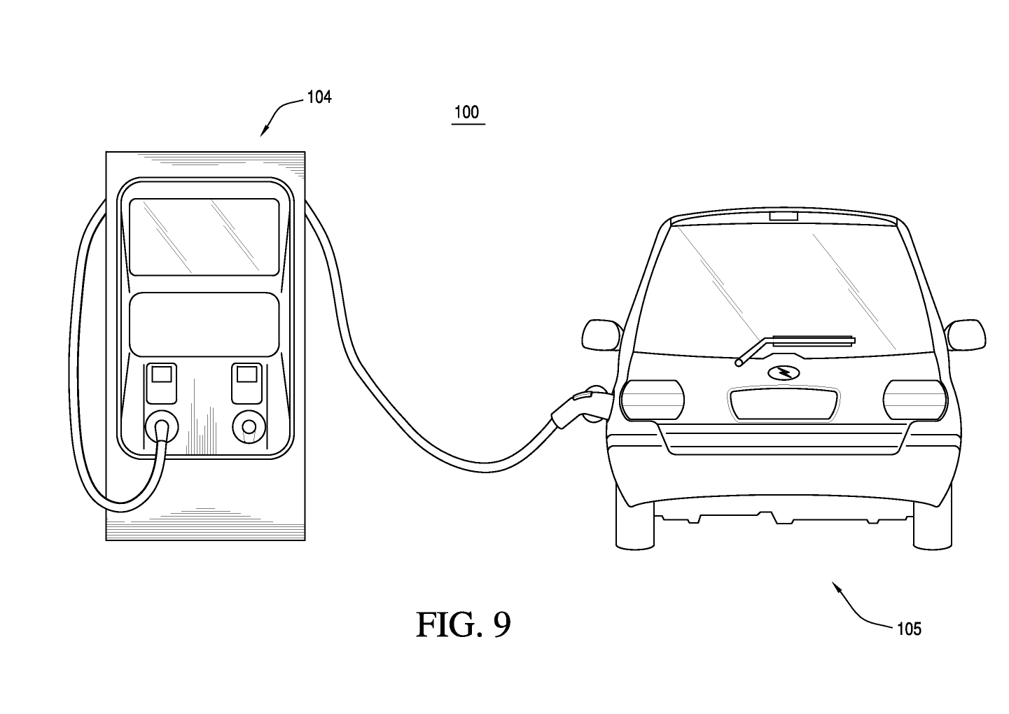

Skipping ahead briefly in the drawings, FIG. 9 illustrates an exemplary embodiment of apparatus 100 in which charging system 104 is providing charging electricity to rechargeable energy storage system 102 of electronic device 105. In these embodiments, apparatus 100 can be calibrating a reference system for rechargeable energy storage system 102 while charging system 104 is providing charging electricity to rechargeable energy storage system 102 of electronic device 105 as described above.

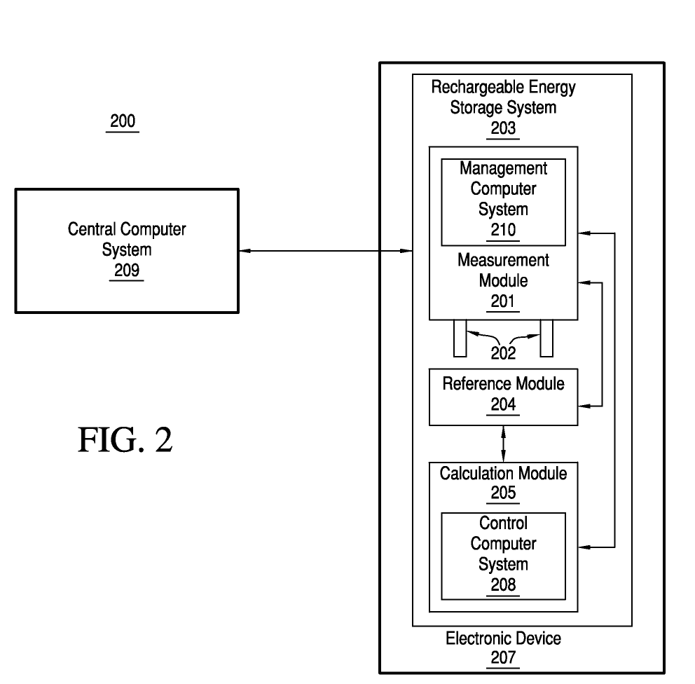

Returning again to the drawings, FIG. 2 illustrates management system 200 for a rechargeable energy storage system, according to an embodiment. Management system 200 is merely exemplary and is not limited to the embodiments presented herein. Management system 200 can be employed in many different embodiments or examples not specifically depicted or described herein. In some embodiments, management system 200 can be similar or identical to management system 107 (FIG. 1). In other embodiments, management system 200 may be separate and/or different from management system 107 (FIG. 1) and may be configured to communicate with a management system of rechargeable energy storage system 203. In these embodiments, the management system can be similar or identical to management system 107 (FIG. 1), and/or management system 200 can be configured to communicate with the management system. Management system 200 can be configured to administrate the operational-side functionality of calculating operational electric current output from a rechargeable energy storage system 203 such as where a reference system has already been calibrated, as described above with respect to apparatus 100 (FIG. 1). Rechargeable energy storage system 203 can be similar or identical to rechargeable energy storage system 102 (FIG. 1). Likewise, the reference system can be similar or identical to the reference system described above with respect to apparatus 100 (FIG. 1).

Management system 200 can comprise electronic device 207, and electronic device 207 and/or rechargeable energy storage system 203 can comprise measurement module 201. Measurement module 201 can comprise management computer system 210 and conductive lines 202. Each conductive line of conductive lines 202 is configured to be coupled to rechargeable energy storage system 203. Conductive lines 202 can be similar or identical to conductive lines 101 (FIG. 1).

Measurement module 201 can be configured to measure the operational electric voltage of rechargeable energy storage system 203 while rechargeable energy storage system 203 is providing operational electricity to electronic device 207. Measurement module 201 can also be configured to measure the operational temperature at rechargeable energy storage system 203 while rechargeable energy storage system 203 is providing operational electricity to electronic device 207. In many embodiments, measurement module 201 can be configured to measure the operational voltage and/or the operational temperature of rechargeable energy storage system 203 in a comparable manner to that described above with respect to apparatus 100 (FIG. 1) and/or control module 103 (FIG. 1). In some examples, where measurement module 201 and the management system of rechargeable energy storage system 203 are separate and/or different, the management system can be configured to measure the operational voltage and/or the operational temperature of rechargeable energy storage system 203, with measurement module 201 merely operating in an administrative capacity to communicate with and/or control the management system. Electronic device 207 can be similar or identical to electronic device 105 (FIG. 1).

Management system 200 also comprises reference module 204. Reference module 204 is configured to reference the reference system. Reference module 204 can reference any of a control computer system 208, a central computer system 209, and/or management computer system 210 in order to reference the reference system, as described below. In some embodiments, electronic device 207 and/or rechargeable energy storage system 203 can comprise reference module 204.

Management system 200 comprises calculation module 205, which comprises control computer system 208. In some embodiments, electronic device 207 and/or rechargeable energy storage system 203 can comprise calculation module 205. Calculation module 205 can be configured to communicate with measurement module 201, reference module 204, control computer system 208, central computer system 209, and/or management computer system 210 via a wired connection (e.g., an electrical bus connection, an Ethernet connection, a Powerline connection, etc.) and/or a wireless connection (e.g., (1) any suitable wireless computer network connection, for example, an 802.11 wireless local area network (WLAN) connection, a Bluetooth connection, and the like, (2) any suitable cellular telephone network connection, for example, a code division multiple access (CDMA) (e.g., IS-95) network, a global system for mobile communications (GSM) network, a time division multiple access (TDMA) network, and/or an orthogonal frequency-division multiplexing (OFDM) network, and the like, and (3) any other suitable wireless connection medium).

Calculation module 205 can be configured to calculate an operational electric current of the operational electricity. In many embodiments, calculation module 205 can be configured to calculate the operational electric current of the operational electricity output by rechargeable energy storage system 203 in a comparable manner to that described above with respect to apparatus 100 (FIG. 1) and/or control module 103 (FIG. 1). In some embodiments, calculation module 205 can be similar or identical to control module 103 (FIG. 1). In many embodiments, calculation module 205 can be control module 103 (FIG. 1). In other embodiments, calculation module 205 can be separate from and/or different from control module 103 (FIG. 1). In various embodiments, calculation module 205 can provide charge data to be recorded and/or stored at any of control computer system 208, central computer system 209, and/or management computer system 210, as described below.

In many embodiments, rechargeable energy storage system 203 can be part of management system 200 while in other embodiments it is not. In many embodiments, measurement module 201, reference module 204, and calculation module 205 can be located at rechargeable energy storage system 203. Still, in other embodiments, measurement module 201 can be located at rechargeable energy storage system 203 while reference module 204 and/or calculation module 205 are located remotely. Where measurement module 201 and the management system of rechargeable energy storage system 203 are separate and/or different, even measurement module 201 can be located apart from rechargeable energy storage system 203 and/or electronic device 207 in some embodiments.

In many embodiments, management system 200 can comprise control computer system 208, central computer system 209 and/or management computer system 210. Control computer system 208 can be similar or identical to control computer system 108 (FIG. 1), central computer system 209 can be similar or identical to central computer system 109 (FIG. 1), and/or management computer system 210 can be similar or identical to management computer system 110 (FIG. 1).

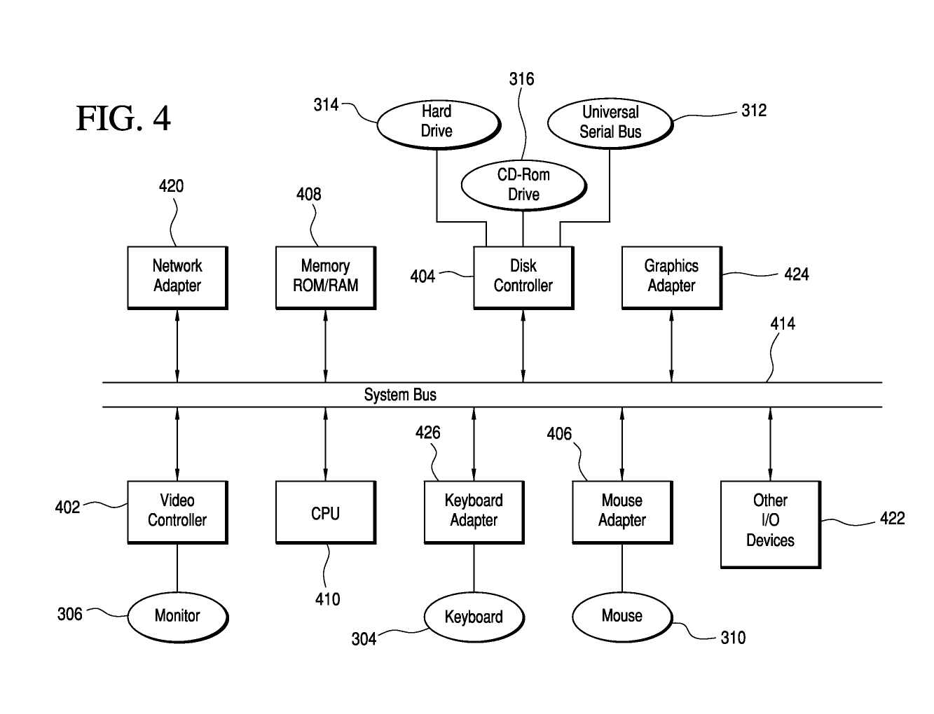

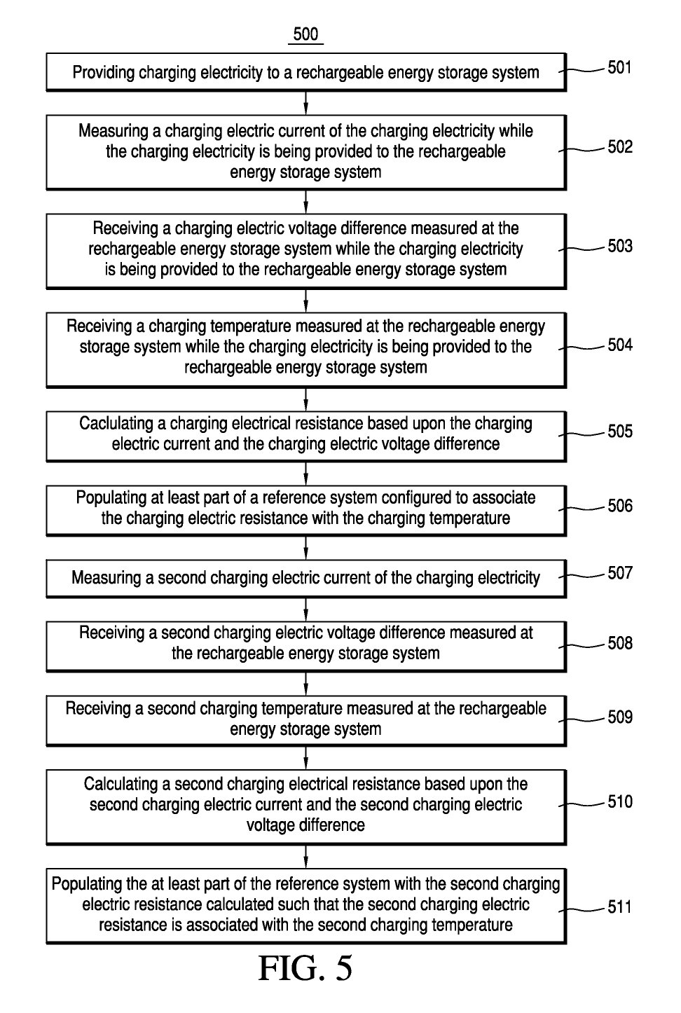

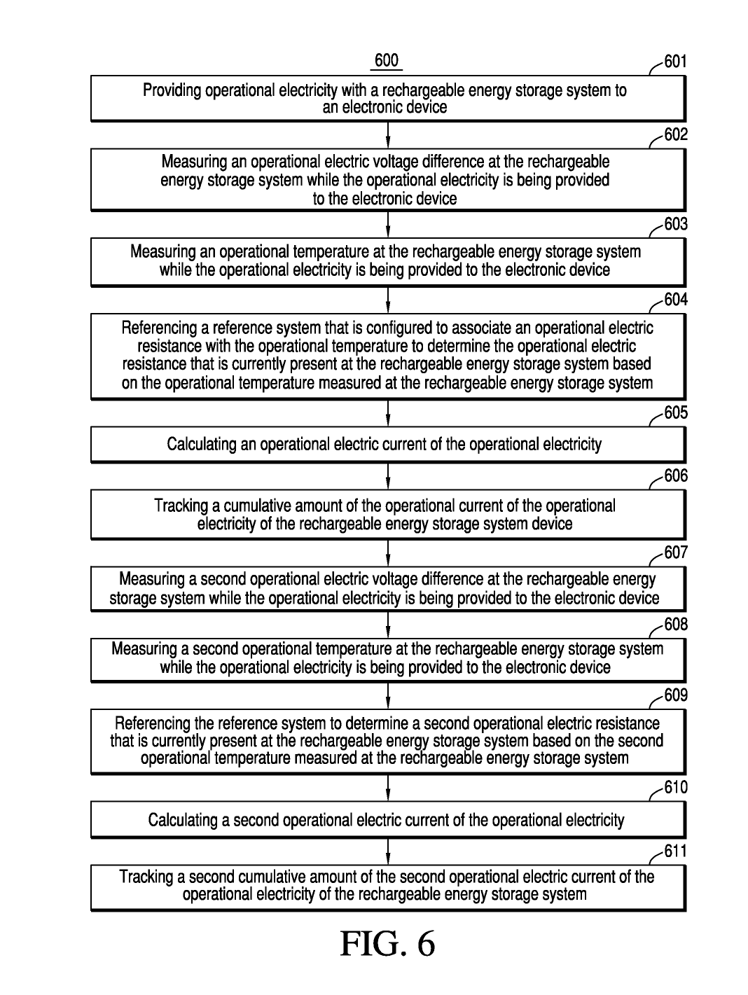

Turning to the next drawing, FIG. 3 illustrates an exemplary embodiment of computer system 300, all of which or a portion of which can be suitable for implementing an embodiment of control computer system 108 (FIG. 1), central computer system 109 (FIG. 1), management computer system 110 (FIG. 1), control computer system 208 (FIG. 2), central computer system 209 (FIG. 2), and/or management computer system 210 (FIG. 2) and/or another part of apparatus 100 (FIG. 1) and/or management system 200 (FIG. 2) as well as any of the various procedures, processes, and/or activities of method 500 (FIG. 5) and/or method 600 (FIG. 6). As an example, a different or separate one of chassis 302 (and its internal components) can be suitable for implementing control computer system 108 (FIG. 1), central computer system 109 (FIG. 1), management computer system 110 (FIG. 1), control computer system 208 (FIG. 2), central computer system 209 (FIG. 2), and/or management computer system 210 (FIG. 2). Furthermore, one or more parts of computer system 300 (e.g., refreshing monitor 306, keyboard 304, and/or mouse 310, etc.) may also be appropriate for implementing central computer system 109 (FIG. 1) and/or central computer system 209 (FIG. 2). Computer system 300 includes chassis 302 containing one or more circuit boards (not shown), Universal Serial Bus (USB) 312, Compact Disc Read-Only Memory (CD-ROM) and/or Digital Video Disc (DVD) drive 316, and hard drive 314. A representative block diagram of the elements included on the circuit boards inside chassis 302 is shown in FIG. 3. Central processing unit (CPU) 410 in FIG. 4 is coupled to system bus 414 in FIG. 4. In various embodiments, the architecture of CPU 410 can be compliant with any of a variety of commercially distributed architecture families.

Turning to FIG. 4, system bus 414 also is coupled to memory 408, where memory 408 includes both read only memory (ROM) and random access memory (RAM). Non-volatile portions of memory 408 or the ROM can be encoded with a boot code sequence suitable for restoring computer system 300 (FIG. 3) to a functional state after a system reset. In addition, memory 408 can include microcode such as a Basic Input-Output System (BIOS). In some examples, the one or more storage modules of the various embodiments disclosed herein can include memory 408, USB 312 (FIGS. 3-4), hard drive 314 (FIGS. 3-4), and/or CD-ROM or DVD drive 316 (FIGS. 3-4). In the same or different examples, the one or more storage modules of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Common operating systems for a mobile electronic device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 4, various I/O devices such as disk controller 404, graphics adapter 424, video controller 402, keyboard adapter 426, mouse adapter 406, network adapter 420, and other I/O devices 422 can be coupled to system bus 414. Keyboard adapter 426 and mouse adapter 406 are coupled to keyboard 304 (FIGS. 3-4) and mouse 310 (FIGS. 3-4), respectively, of computer system 300 (FIG. 3). While graphics adapter 424 and video controller 402 are indicated as distinct units in FIG. 4, video controller 402 can be integrated into graphics adapter 424, or vice versa in other embodiments. Video controller 402 is suitable for refreshing monitor 306 (FIGS. 3-4) to display images on a screen 308 (FIG. 3) of computer system 300 (FIG. 3). Disk controller 404 can control hard drive 314 (FIGS. 3-4), USB 312 (FIGS. 3-4), and CD-ROM drive 316 (FIGS. 3-4). In other embodiments, distinct units can be used to control each of these devices separately.

In some embodiments, network adapter 420 can be part of a WNIC (wireless network interface controller) card (not shown) plugged or coupled to an expansion port (not shown) in computer system 300. In other embodiments, the WNIC card can be a wireless network card built into computer system 300. A wireless network adapter can be built into computer system 300 by having wireless Ethernet capabilities integrated into the motherboard chipset (not shown), or implemented via a dedicated wireless Ethernet chip (not shown), connected through the PCI (peripheral component interconnector) or a PCI express bus. In other embodiments, network adapter 420 can be a wired network adapter.

Although many other components of computer system 300 (FIG. 3) are not shown, such components and their interconnection are well known to those of ordinary skill in the art. Accordingly, further details concerning the construction and composition of computer system 300 and the circuit boards inside chassis 302 (FIG. 3) are not discussed herein.

When computer system 300 in FIG. 3 is running, program instructions stored on a USB-equipped electronic device connected to USB 312, on a CD-ROM or DVD in CD-ROM and/or DVD drive 316, on hard drive 314, or in memory 408 (FIG. 4) are executed by CPU 410 (FIG. 4). A portion of the program instructions, stored on these devices, can be suitable for carrying out at least part of apparatus 100 (FIG. 1) and/or management system 200 (FIG. 2) as well as any of the various procedures, processes, and/or activities of method 500 (FIG. 5) and/or method 600 (FIG. 6).

Although computer system 300 is illustrated as a desktop computer in FIG. 3, there can be examples where computer system 300 may take a different form factor while still having functional elements similar to those described for computer system 300. In some embodiments, computer system 300 may comprise a single computer, a single server, or a cluster or collection of computers or servers, or a cloud of computers or servers. Typically, a cluster or collection of servers can be used when the demand on computer system 300 exceeds the reasonable capability of a single server or computer.

Meanwhile, in some embodiments, one or more of control computer system 108 (FIG. 1), management computer system 110 (FIG. 1), control computer system 208 (FIG. 2), and/or management computer system 210 (FIG. 2) may not have the level of sophistication and/or complexity of central computer system 109 (FIG. 1) and/or central computer system 209 (FIG. 2). For example, one or more of control computer system 108 (FIG. 1), management computer system 110 (FIG. 1), control computer system 208 (FIG. 2), and/or management computer system 210 (FIG. 2) may only have those processing capabilities and/or memory storage capabilities as are reasonably necessary to make the measurements and/or perform the mathematical calculations, described above with respect to apparatus 100 (FIG. 1) and/or management system 200 (FIG. 2). In these examples, one or more of control computer system 108 (FIG. 1), management computer system 110 (FIG. 1), control computer system 208 (FIG. 2), and/or management computer system 210 (FIG. 2) could be implemented as a microcontroller comprising flash memory, or the like. Reducing the sophistication and/or complexity of one or more of control computer system 108 (FIG. 1), management computer system 110 (FIG. 1), control computer system 208 (FIG. 2), and/or management computer system 210 (FIG. 2) can reduce the size and/or cost of implementing apparatus 100 (FIG. 1) and/or management system 200 (FIG. 2). Nonetheless, in other embodiments, one or more of control computer system 108 (FIG. 1), management computer system 110 (FIG. 1), control computer system 208 (FIG. 2), and/or management computer system 210 (FIG. 2) may need additional sophistication and/or complexity to operate as desired.

FIG. 5 illustrates a flow chart for an embodiment of a method 500. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of the method 500 can be performed in any other suitable order. In still other embodiments, one or more of the procedures, the processes, and/or the activities in method 500 can be combined or skipped.

Method 500 comprises procedure 501 of providing charging electricity to a rechargeable energy storage system. The rechargeable energy storage system can be similar or identical to rechargeable energy storage system 102 (FIG. 1) and/or rechargeable energy storage system 203 (FIG. 2). The charging electricity can be similar or identical to the charging electricity described above with respect to apparatus 100 (FIG. 1). In some embodiments, procedure 501 can comprise providing charging electricity to the rechargeable energy storage system with an electric vehicle charging station. The electric vehicle charging station can be similar or identical to the electric vehicle charging station described above with respect to apparatus 100 (FIG. 1). In many embodiments, performing procedure 501 can be similar or identical to provide charging electricity to the rechargeable energy storage system as described above with respect to apparatus 100 (FIG. 1).

Method 500 comprises procedure 502 of measuring a charging electric current of the charging electricity while the charging electricity is being provided to the rechargeable energy storage system. In many embodiments, performing procedure 502 can be similar or identical to measuring the charging electric current of the charging electricity as described above with respect to apparatus 100 (FIG. 1).

Method 500 comprises procedure 503 of receiving a charging electric voltage difference measured at the rechargeable energy storage system while the charging electricity is being provided to the rechargeable energy storage system. In many embodiments, performing procedure 503 can be similar or identical to receiving the charging electric voltage difference at the rechargeable energy storage system as described above with respect to apparatus 100 (FIG. 1). In some embodiments, procedure 503 can include measuring the charging electric voltage difference at the rechargeable energy storage system.

Method 500 comprises procedure 504 of receiving a charging temperature measured at the rechargeable energy storage system while the charging electricity is being provided to the rechargeable energy storage system. Procedures 501-504 can occur substantially simultaneously with each other. In many embodiments, performing procedure 504 can be similar or identical to receiving the charging temperature measured at the rechargeable energy storage system as described above with respect to apparatus 100 (FIG. 1). In some embodiments, procedure 504 can include measuring the charging temperature at the rechargeable energy storage system.

Method 500 comprises procedure 505 of calculating a charging electrical resistance based upon the charging electric current and the charging electric voltage difference. In many embodiments, performing procedure 505 can be similar or identical to calculating the charging electrical resistance based upon the charging electric current and the charging electric voltage difference as described above with respect to apparatus 100 (FIG. 1).

Method 500 comprises procedure 506 of populating at least part of a reference system configured to associate the charging electric resistance with the charging temperature. The reference system can be similar or identical to the reference system described above with respect to apparatus 100 (FIG. 1). In many embodiments, performing procedure 506 can be similar or identical to populating at least part of the reference system configured to associate the charging electric resistance with the charging temperature as described above with respect to apparatus 100 (FIG. 1).

Method 500 can further comprise procedure 507 of measuring a second charging electric current of the charging electricity. Procedure 507 can be performed and/or can occur while and/or after procedure 501 is performed and/or occurs. In the same or different embodiments, procedure 507 can be performed and/or can occur after procedures 502-504 are performed and/or occur. In many embodiments, performing procedure 507 can occur as part of the same calibration procedure as procedure 502 or can occur as part of another calibration procedure. Performing the calibration procedure(s) can be similar or identical to performing the calibration(s) as described above with respect to apparatus 100 (FIG. 1).

Method 500 can further comprise procedure 508 of receiving a second charging electric voltage difference measured at the rechargeable energy storage system. Procedure 508 can be performed and/or can occur while and/or after procedure 501 is performed and/or occurs. In the same or different embodiments, procedure 508 can be performed and/or can occur after procedures 502-504 are performed and/or occur. In many embodiments, performing procedure 508 can occur as part of the same calibration procedure as procedure 503 or can occur as part of another calibration procedure. Performing the calibration procedure(s) can be similar or identical to performing the calibration(s) as described above with respect to apparatus 100 (FIG. 1). In some embodiments, procedure 508 can include measuring the second charging electric voltage difference at the rechargeable energy storage system.

Method 500 can further comprise procedure 509 of receiving a second charging temperature measured at the rechargeable energy storage system. Procedure 509 can be performed and/or can occur while and/or after procedure 501 is performed and/or occurs. In the same or different embodiments, procedure 509 can be performed and/or can occur after procedures 502-504 are performed and/or occur. In many embodiments, performing procedure 509 can occur as part of the same calibration procedure as procedure 504 or can occur as part of another calibration procedure. Performing the calibration procedure(s) can be similar or identical to performing the calibration(s) as described above with respect to apparatus 100 (FIG. 1). Procedures 501 and 507-509 can occur substantially simultaneously with each other. Also, procedure 509 can include measuring the second charging temperature at the rechargeable energy storage system.

Method 500 can comprise procedure 510 of calculating a second charging electrical resistance based upon the second charging electric current and the second charging electric voltage difference. In many embodiments, performing procedure 510 can occur as part of the same calibration procedure as procedure 505 or can occur as part of another calibration procedure. Performing the calibration procedure(s) can be similar or identical to performing the calibration(s) as described above with respect to apparatus 100 (FIG. 1). In some embodiments, procedures 505 and 510 can occur after or during procedure 501.

Method 500 can comprise procedure 511 of populating at least part of the reference system with the second charging electric resistance calculated such that the second charging electric resistance is associated with the second charging temperature. In many embodiments, performing procedure 511 can occur as part of a same calibration procedure as procedure 506 or can occur as part of another calibration procedure. Performing the calibration procedure(s) can be similar or identical to performing the calibration(s) as described above with respect to apparatus 100 (FIG. 1). In some embodiments, procedures 506 and 511 can occur after or during procedure 501.

In some embodiments of method 500, there can be a predetermined time period between procedures 502-504 and procedures 507-509. For example, the time period can be 10 seconds, 30 seconds, 1 minute, 2 minutes, 3 minutes, 5 minutes, 10 minutes, etc. In other embodiments of method 500, procedures 507-509 occur after procedures 502-504, but if the second charging temperature of procedure 509 is the same as the charging temperature of procedure 504, then procedures 510 and 511 can be skipped. In the same or different embodiments of method 500, procedures 502-511 can be repeated one or more times during procedure 501.

FIG. 6 illustrates a flow chart for an embodiment of method 600. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of the method 600 can be performed in any other suitable order. In still other embodiments, one or more of the procedures, the processes, and/or the activities in method 600 can be combined or skipped.

Method 600 comprises procedure 601 of providing operational electricity with a rechargeable energy storage system to an electronic device. The rechargeable energy storage system can be similar or identical to rechargeable energy storage system 102 (FIG. 1) and/or rechargeable energy storage system 203 (FIG. 2). The electronic device can be similar or identical to electronic device 105 (FIG. 1) and/or electronic device 207 (FIG. 2). The operational electricity can be similar or identical to the operational electricity described above with respect to apparatus 100 (FIG. 1) and/or management system 200 (FIG. 2). Performing procedure 601 can be similar or identical to providing operational electricity with the rechargeable energy storage system to the electronic device, as described above with respect to apparatus 100 (FIG. 1) and/or management system 200 (FIG. 2).

Method 600 comprises procedure 602 of measuring an operational electric voltage difference at the rechargeable energy storage system while the operational electricity is being provided to the electronic device. Performing procedure 602 can be similar or identical to measuring the operational electric voltage difference at the rechargeable energy storage system, as described above with respect to apparatus 100 (FIG. 1) and/or management system 200 (FIG. 2).

Method 600 comprises procedure 603 of measuring an operational temperature at the rechargeable energy storage system while the operational electricity is being provided to the electronic device. Procedures 601-603 can be performed substantially simultaneously with each other. Performing procedure 603 can be similar or identical to measuring the operational temperature at the rechargeable energy storage system while the operational electricity is being provided to the electronic device, as described above with respect to apparatus 100 (FIG. 1) and/or management system 200 (FIG. 2).

Method 600 comprises procedure 604 of referencing a reference system that is configured to associate an operational electric resistance with the operational temperature to determine the operational electric resistance that is present at the rechargeable energy storage system based on the operational temperature measured at the rechargeable energy storage system. Performing procedure 604 can be similar or identical to referencing the reference system that is configured to associate the operational electric resistance with the operational temperature to determine the operational electric resistance that is present at the rechargeable energy storage system based on the operational temperature measured at the rechargeable energy storage system, as described above with respect to apparatus 100 (FIG. 1) and/or management system 200 (FIG. 2).

Method 600 comprises procedure 605 of calculating an operational electric current of the operational electricity of the rechargeable energy storage system. Performing procedure 605 can be similar or identical to calculating the operational electric current of the operational electricity, as described above with respect to apparatus 100 (FIG. 1) and/or management system 200 (FIG. 2).

Method 600 can comprise procedure 606 of tracking a cumulative amount of the operational electric current of the operational electricity of the rechargeable energy storage system. In some embodiments, performing procedure 606 can comprise tracking the cumulative amount of the operational electric current of the operational electricity of the rechargeable energy storage system at a user display (e.g., a gauge) of the electronic device (e.g., an electric vehicle). In other embodiments, performing procedure 606 can comprise recording as charge data the cumulative amount of the operational electric current of the operational electricity of the rechargeable energy storage system at a computer database. The charge data can be similar or identical to the charge data as described above with respect to apparatus 100 (FIG. 1) and/or management system 200 (FIG. 2). In some embodiments, performing procedure 606 can be similar or identical to tracking the cumulative amount of the operational electric current of the operational electricity of the rechargeable energy storage system, as described above with respect to apparatus 100 (FIG. 1) and/or management system 200 (FIG. 2).

Method 600 can comprise procedure 607 of measuring a second operational electric voltage difference at the rechargeable energy storage system while the operational electricity is being provided to the electronic device. Procedure 607 can be performed and/or can occur while and/or after procedure 601 is performed and/or occurs. In the same or different embodiments, procedure 607 can be performed and/or can occur after procedure 602 is performed and/or occurs. Performing procedure 607 can be similar or identical to measuring another operational electric voltage difference at the rechargeable energy storage system while the operational electricity is being provided to the electronic device, as described above with respect to apparatus 100 (FIG. 1) and/or management system 200 (FIG. 2).

Method 600 can comprise procedure 608 of measuring a second operational temperature at the rechargeable energy storage system while the operational electricity is being provided to the electronic device. Procedure 608 can be performed and/or can occur while and/or after procedure 601 is performed and/or occurs. In fact, procedures 601 and 607-608 can be performed substantially simultaneously with each other. In the same or different embodiments, procedure 608 can be performed and/or can occur after procedure 603 is performed and/or occurs. Performing procedure 608 can be similar or identical to measuring another operational temperature at the rechargeable energy storage system while the operational electricity is being provided to the electronic device, as described above with respect to apparatus 100 (FIG. 1) and/or management system 200 (FIG. 2).

Method 600 can comprise procedure 609 of referencing the reference system to determine a second operational electric resistance that is present at the rechargeable energy storage system based on the second operational temperature measured at the rechargeable energy storage system. Performing procedure 609 can be similar or identical to referencing the reference system to determine another operational electric resistance that is present at the rechargeable energy storage system based on the second operational temperature measured at the rechargeable energy storage system, as described above with respect to apparatus 100 (FIG. 1) and/or management system 200 (FIG. 2). In some embodiments, procedures 604 and 608 can occur after or during procedure 601.

Method 600 can comprise procedure 610 of calculating a second operational electric current of the operational electricity of the rechargeable energy storage system. Performing procedure 609 can be similar or identical to calculating another operational electric current of the operational electricity, as described above with respect to apparatus 100 (FIG. 1) and/or management system 200 (FIG. 2). In some embodiments, procedures 605 and 609 can occur after or during procedure 601.

Method 600 can comprise procedure 611 of tracking a second cumulative amount of the second operational electric current of the operational electricity of the rechargeable energy storage system. Performing procedure 611 can be similar or identical to performing procedure 606 but for the second cumulative amount of the second operational electric current of the operational electricity of the rechargeable energy storage system.

In some embodiments of method 600, there can be a predetermined time period between (1) procedures 602-603 and (2) procedures 607-608. For example, the time period can be 10 seconds, 30 seconds, 1 minute, 2 minutes, 3 minutes, 5 minutes, 10 minutes, etc. In other embodiments of method 600, procedures 607-608 occur after procedures 602-603, but if the second operational temperature of procedure 608 is the same as the operational temperature of procedure 603, then procedure 609 and/or procedure 610 can be skipped. In the same or different embodiments of method 600, procedures 602-611 can be repeated one or more times during procedure 601. Also, in the same or different embodiments of method 600, procedures 601-611 can occur after procedures 501-511 in FIG. 5.

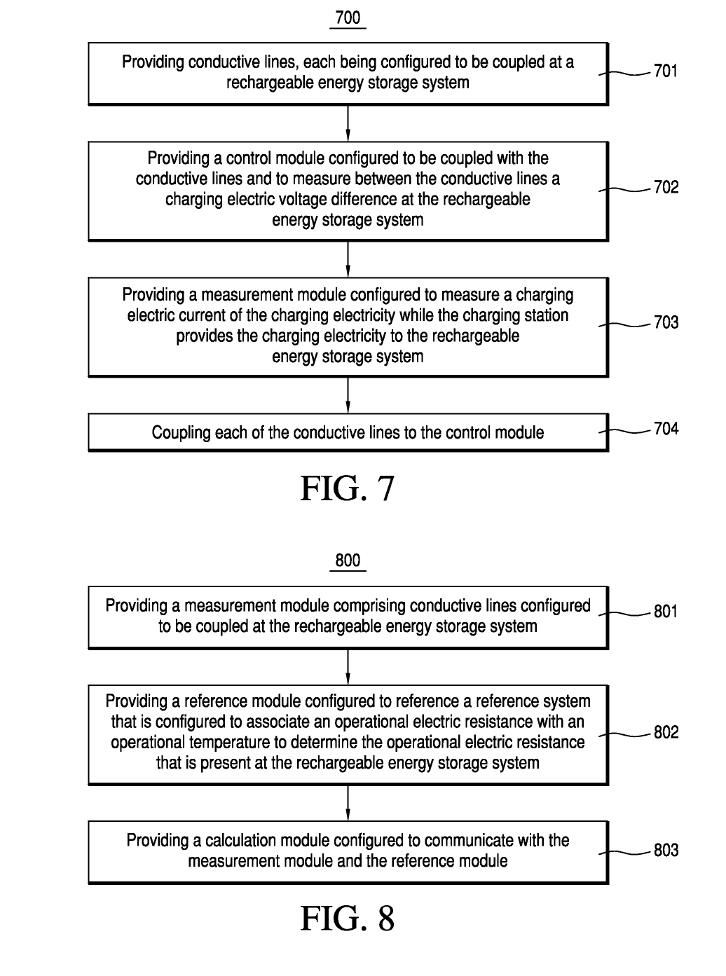

FIG. 7 illustrates a flow chart for an embodiment of method 700 of providing an apparatus. Method 700 is merely exemplary and is not limited to the embodiments presented herein. Method 700 can be employed in many different embodiments or examples not specifically depicted or described herein. In some embodiments, the procedures, the processes, and/or the activities of method 700 can be performed in the order presented. In other embodiments, the procedures, the processes, and/or the activities of the method 700 can be performed in any other suitable order. In still other embodiments, one or more of the procedures, the processes, and/or the activities in method 700 can be combined or skipped. In many embodiments, the apparatus can be similar or identical to apparatus 100 (FIG. 1).

Method 700 can comprise procedure 701 of providing conductive lines, each being configured to be coupled at a rechargeable energy storage system. The conductive lines can be similar or identical to conductive lines 101 (FIG. 1). The rechargeable energy storage system can be similar or identical to rechargeable energy storage system 102 (FIG. 1) and/or rechargeable energy storage system 203 (FIG. 2).

Method 700 can comprise procedure 702 of providing a control module configured to be coupled with the conductive lines and to measure between the conductive lines a charging electric voltage difference at the rechargeable energy storage system. The control module can be similar or identical to control module 103 (FIG. 1).

Method 700 can comprise procedure 703 of providing a measurement module configured to measure a charging electric current of the charging electricity while the charging station provides the charging electricity to the rechargeable energy storage system. The measurement module can be similar or identical to measurement module 111 (FIG. 1).

Method 700 can comprise procedure 704 of coupling each of the conductive lines to the control module.

In some embodiments of method 700, procedures 701-704 can occur before procedures 501-511 in FIG. 5.

FIG. 8 illustrates a flow chart for an embodiment of a method 800 of providing a management system for a rechargeable energy storage system. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of the method 800 can be performed in any other suitable order. In still other embodiments, one or more of the procedures, the processes, and/or the activities in method 800 can be combined or skipped. The management system can be similar or identical to management system 200 (FIG. 2).

Method 800 comprises procedure 801 of providing a measurement module comprising conductive lines configured to be coupled at the rechargeable energy storage system. The measurement module can be similar or identical to measurement module 201 (FIG. 2) and/or management system 107 (FIG. 1). The conductive lines can be similar or identical to conductive lines 202 (FIG. 2) and/or conductive lines 101 (FIG. 1).

Method 800 comprises procedure 802 of providing a reference module configured to reference a reference system that is configured to associate an operational electric resistance with an operational temperature to determine the operational electric resistance that is present at the rechargeable energy storage system. The reference system can be similar or identical to the reference system as described above with respect to apparatus 100 (FIG. 1) and/or management system 200 (FIG. 2). As one of many examples, the reference module can be similar or identical to reference module 204 (FIG. 2) and/or management system 107 (FIG. 1).

Method 800 comprises procedure 803 of providing a calculation module configured to communicate with the measurement module and the reference module. The calculation module can be similar or identical to calculation module 205 (FIG. 2) and/or management system 107 (FIG. 1).

Although, for exemplary purposes, the invention has been described in large part with respect to rechargeable energy storage systems, the invention (e.g., apparatus 100, management system 200, method 500, method 600, method 700, and/or method 800) could also be implemented in any suitable situation for which electricity having a known electric current and/or an electric current that is readily measureable at the source of the electricity will pass through a conductive element during a first time period and then will pass again through the conductive element for a second period of time during which the electric current is unknown and/or not readily measureable at the source of the electricity, such as, where it might be impractical to employ at the source of the electricity a Hall effect sensor, a magnetic field based detector, or another similar device for measuring electric current. For example, in some embodiments, the invention may be implemented in conjunction with a solar electric device, a wind electric device, and/or a hydro electric device, etc. to determine an electric current of electricity being generated thereby.

Likewise, although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 501-511 of FIG. 5, procedures 601-611 of FIG. 6, procedures 701-704, and procedures 801-803 may be comprised of many different procedures, processes, and activities and be performed by many different modules, in many different orders, that any element of FIGS. 1-8 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method comprising:
providing charging electricity to a rechargeable energy storage system;
measuring a charging electric current of the charging electricity while the charging electricity is being provided to the rechargeable energy storage system;
receiving a charging electric voltage difference measured at the rechargeable energy storage system while the charging electricity is being provided to the rechargeable energy storage system;
receiving a charging temperature measured at the rechargeable energy storage system while the charging electricity is being provided to the rechargeable energy storage system;
calculating a charging electrical resistance based upon the charging electric current and the charging electric voltage difference; and
populating at least a first portion of a reference system configured to associate the charging electric resistance with the charging temperature, wherein the reference system is configured to be referenced to provide an operational electric resistance based upon an operational temperature measured at the rechargeable energy storage system in order to calculate an operational electric current provided by the rechargeable energy storage system to an electronic device.

2) The method of claim 1 wherein:
providing the charging electricity to the rechargeable energy storage system comprises using an electric vehicle charging station to provide the charging electricity to the rechargeable energy storage system;
the electronic device comprises an electric vehicle; and
the electric vehicle comprises the rechargeable energy storage system.

3) The method of claim 1 wherein:
measuring the charging electric current of the charging electricity comprises using a Hall effect sensor to measure the charging electric current of the charging electricity while the charging electricity is being provided to the rechargeable energy storage system.

4) The method of claim 1 wherein:
receiving the charging electric voltage difference measured at the rechargeable energy storage system comprises measuring the charging electric voltage difference at the rechargeable energy storage system while the charging electricity is being provided to the rechargeable energy storage system.

5) The method of claim 1 wherein:
receiving the charging electric voltage difference measured at the rechargeable energy storage system comprises receiving the charging electric voltage difference measured across a conductive element of the rechargeable energy storage system while at least a portion of the charging electricity being provided to the rechargeable energy storage system is passing through the conductive element; and
the conductive element comprises an intercell connector.

6) The method of claim 5 further comprising:
coupling conductive lines to opposing ends of the conductive element;
wherein:
receiving the charging electric voltage difference measured across the conductive element of the rechargeable energy storage system comprises measuring the charging electric voltage difference between the opposing ends of the conductive element to determine the charging electric voltage difference across the conductive element.

7) The method of claim 1 wherein:
receiving the charging temperature measured at the rechargeable energy storage system comprises measuring the charging temperature of a conductive element of the rechargeable energy storage system while at least a portion of the charging electricity being provided to the rechargeable energy storage system is passing through the conductive element; and
the conductive element comprises an intercell connector.

8) The method of claim 1 wherein:
populating at least the first portion of the reference system configured to associate the charging electric resistance with the charging temperature comprises updating at least the first portion of the reference system with the charging electric resistance calculated based upon the charging electric current and the charging electric voltage difference such that the charging electric resistance is associated with the charging temperature measured at the rechargeable energy storage system.

9) The method of claim 1 wherein:
populating at least the first portion of the reference system configured to associate the charging electric resistance with the charging temperature comprises storing the charging temperature and the charging electric resistance calculated based upon the charging electric current and the charging electric voltage difference as at least part of a table that is stored at a computer system such that the charging electric resistance is associated with the charging temperature;
the reference system comprises the table, the operational electric resistance is approximately equal to the charging electric resistance; and
the operational temperature is approximately equal to the charging temperature.

10) The method of claim 1 further comprising:
after measuring the charging electric current of the charging electricity, measuring a second charging electric current of the charging electricity while the charging electricity is being provided to the rechargeable energy storage system;
after receiving the charging electric voltage difference measured at the rechargeable energy storage system, receiving a second charging electric voltage difference measured at the rechargeable energy storage system while the charging electricity is being provided to the rechargeable energy storage system;
after receiving the charging temperature measured at the rechargeable energy storage system, receiving a second charging temperature measured at the rechargeable energy storage system while the charging electricity is being provided to the rechargeable energy storage system;
calculating a second charging electrical resistance based upon the second charging electric current and the second charging electric voltage difference; and
populating at least a second portion of the reference system with the second charging electric resistance and the second charging temperature.

11) A method comprising:
providing operational electricity from a rechargeable energy storage system to an electronic device;
measuring an operational electric voltage difference at the rechargeable energy storage system while the operational electricity is being provided to the electronic device;
measuring an operational temperature at the rechargeable energy storage system while the operational electricity is being provided to the electronic device;
referencing a reference system that is configured to associate an operational electric resistance with the operational temperature to determine the operational electric resistance that is present at the rechargeable energy storage system based on the operational temperature measured at the rechargeable energy storage system; and
calculating an operational electric current of the operational electricity using the operational electric voltage difference and the operational electric resistance.

12) An apparatus for providing charging electricity to a rechargeable energy storage system, the apparatus comprising:
conductive lines configured to be coupled to the rechargeable energy storage system;
a control module configured to be coupled with the conductive lines and to measure between the conductive lines a charging electric voltage difference at the rechargeable energy storage system while the charging station provides the charging electricity to the rechargeable energy storage system; and
a measurement module configured to measure a charging electric current of the charging electricity while the charging station provides the charging electricity to the rechargeable energy storage system;
wherein:
the control module is configured to receive from the measurement module a measurement of the charging electric current of the charging electricity and to receive a second measurement of a charging temperature at the rechargeable energy storage system;
the control module is configured to calculate a charging electric resistance based upon the charging electric current and the charging electric voltage difference;
the control module is configured to populate at least part of a reference system with the charging electric resistance such that the charging electric resistance is associated with the charging temperature; and
the reference system is configured to be referenced to provide an operational electric resistance based upon an operational temperature measured at the rechargeable energy storage system in order to calculate an operational electric current provided by the rechargeable energy storage system to an electronic device.

13) The apparatus of claim 12 wherein:
the rechargeable energy storage system is configured to provide operational electricity to an electronic device.

14) The apparatus of claim 13 wherein:
the electronic device comprises an electric vehicle;
the electric vehicle comprises the rechargeable energy storage system; and
the charging system comprises an electric vehicle charging station.

15) The apparatus of claim 12 wherein:
the rechargeable energy storage system comprises a conductive element;
each of the conductive lines is configured to be coupled to opposing ends of the conductive element;
the conductive element is configured such that at least a portion of the charging electricity passes through the conductive element when the charging system is providing the charging electricity to the rechargeable energy storage system; and
the control module is configured to measure between the conductive lines the charging electric voltage difference across the conductive element while at least the portion of the charging electricity passes through the conductive element.

16) The apparatus of claim 15 wherein:
the conductive element comprises an intercell connector.

17) The apparatus of claim 15 wherein:
the control module is configured to receive the second measurement of the charging temperature at the rechargeable energy storage system by measuring the charging temperature of the conductive element.

18) The apparatus of claim 15 wherein:
the rechargeable energy storage system comprises a management system;
the control module is configured to receive the second measurement of the charging temperature at the rechargeable energy storage system from the management system; and
the management system is configured to measure the charging temperature of the conductive element.

19) The apparatus of claim 12 further comprising:
the rechargeable energy storage system.

20) The apparatus of claim 12 further comprising:
a computer system;
wherein:
the reference system comprises a table configured to associate the charging electric resistance with the charging temperature;
the computer system is configured to store the table; and
the control module is configured to communicate with the computer system to provide the charging electric resistance to the computer system in order to store the charging electric resistance as part of the table such that the charging electric resistance is associated with the charging temperature.

21) The apparatus of claim 12 wherein:
the reference system comprises a table configured to associate the charging electric resistance with the charging temperature;
the control module is configured to communicate with a computer system to provide the charging electric resistance to the computer system in order to store the charging electric resistance as part of the table such that the charging electric resistance is associated with the charging temperature; and
the computer system is located apart from the control module.

22) The apparatus of claim 12 wherein:
the reference system comprises an existing charging electric resistance; and
whenever the apparatus subsequently provides charging electricity to the rechargeable energy storage system, the control module is configured to repopulate the at least part of the reference system with a new charging electric resistance associated with the charging temperature if the new charging electric resistance differs from the existing charging electric resistance.

23) A management system for a rechargeable energy storage system, the management system comprising:
a measurement module comprising conductive lines configured to be coupled to the rechargeable energy storage system;
a reference module configured to reference a reference system that associates an operational electric resistance with an operational temperature to determine the operational electric resistance of the rechargeable energy storage system; and
a calculation module configured to communicate with the measurement module and the reference module;
wherein:
the measurement module is configured to measure between the conductive lines an operational electric voltage difference at the rechargeable energy storage system while the rechargeable energy storage system is providing operational electricity to an electronic device;
the measurement module is configured to measure the operational temperature at the rechargeable energy storage system while the rechargeable energy storage system is providing operational electricity to the electronic device; and
the calculation module is configured to calculate an operational electric current of the operational electricity by using the operational electric resistance of the operational electric voltage difference.

24) A method of providing an apparatus for providing charging electricity to a rechargeable energy storage system, the method comprising:
providing conductive lines configured to be coupled to the rechargeable energy storage system;
providing a control module configured to be coupled with the conductive lines and to measure between the conductive lines a charging electric voltage difference at the rechargeable energy storage system; and
providing a measurement module configured to measure a charging electric current of the charging electricity while the charging station provides the charging electricity to the rechargeable energy storage system;
coupling each of the conductive lines to the control module;
wherein:
the control module is configured to receive from the measurement module a measurement of the charging electric current of the charging electricity and to receive a second measurement of a charging temperature at the rechargeable energy storage system;
the control module is configured to calculate a charging electric resistance based upon the charging electric current and the charging electric voltage difference;
the control module is configured to populate at least part of a reference system with the charging electric resistance such that the charging electric resistance is associated with the charging temperature; and
the reference system is configured to be referenced to provide an operational electric resistance based upon an operational temperature measured at the rechargeable energy storage system in order to calculate an operational electric current provided by the rechargeable energy storage system to an electronic device.

25) The method of claim 24 wherein:
the rechargeable energy storage system is configured to provide operational electricity to an electronic device.

26) The method of claim 25 wherein:
the electronic device comprises an electric vehicle;
the electric vehicle comprises the rechargeable energy storage system; and
the charging system comprises an electric vehicle charging station.

27) The method of claim 24 wherein:
the rechargeable energy storage system comprises a conductive element;
each of the conductive lines is configured to be coupled to opposing ends of the conductive element;
the conductive element is configured such that at least a portion of the charging electricity passes through the conductive element when the charging system is providing the charging electricity to the rechargeable energy storage system; and
the control module is configured to measure between the conductive lines the charging electric voltage difference across the conductive element while at least the portion of the charging electricity passes through the conductive element.

28) The method of claim 27 wherein:
the conductive element comprises an intercell connector.

29) The method of claim 27 wherein:
the control module is configured to receive the second measurement of the charging temperature at the rechargeable energy storage system by measuring the charging temperature of the conductive element.

30) The method of claim 27 wherein:
the rechargeable energy storage system comprises a management system;
the control module is configured to receive the second measurement of the charging temperature at the rechargeable energy storage system from the management system; and
the management system is configured to measure the charging temperature of the conductive element.

31) The method of claim 24 wherein:
the apparatus comprises the rechargeable energy storage system.

32) The method of claim 24 wherein:
the apparatus comprises a computer system;
the reference system comprises a table configured to associate the charging electric resistance with the charging temperature;
the computer system is configured to store the table; and
the control module is configured to communicate with the computer system to provide the charging electric resistance to the computer system in order to store the charging electric resistance as part of the table such that the charging electric resistance is associated with the charging temperature.

33) The method of claim 24 wherein:
the reference system comprises a table configured to associate the charging electric resistance with the charging temperature;
the control module is configured to communicate with a computer system to provide the charging electric resistance to the computer system in order to store the charging electric resistance as part of the table such that the charging electric resistance is associated with the charging temperature; and
the computer system is located apart from the control module.

34) The method of claim 24 wherein:
the reference system comprises an existing charging electric resistance; and
whenever the apparatus subsequently provides charging electricity to the rechargeable energy storage system, the control module is configured to repopulate at least part of the reference system with a new charging electric resistance associated with the charging temperature if the new charging electric resistance differs from the existing charging electric resistance.

35) A method of providing a management system for a rechargeable energy storage system, the method comprising:
providing a measurement module comprising conductive lines configured to be coupled to the rechargeable energy storage system;
providing a reference module configured to reference a reference system that associates an operational electric resistance with an operational temperature to determine the operational electric resistance of the rechargeable energy storage system; and
providing a calculation module configured to communicate with the measurement module and the reference module;
wherein:
the measurement module is configured to measure between the conductive lines an operational electric voltage difference at the rechargeable energy storage system while the rechargeable energy storage system is providing operational electricity to an electronic device;
the measurement module is configured to measure the operational temperature at the rechargeable energy storage system while the rechargeable energy storage system is providing operational electricity to the electronic device; and
the calculation module is configured to calculate an operational electric current of the operational electricity by using the operational electric resistance and the operational electric voltage difference.
